(19) United States
(12) Patent Application Publication
(10) Pub. No.: US 2004/0151571 A1
(43) Pub. Date: Aug. 5, 2004

(54) Plate loader

(76) Inventors: Avi Zahavi, Hod Hasharon (IL); Yehuda Barnes Solomon, Rishon Lezion (IL)

Correspondence Address: WILMER CUTLER PICKERING HALE AND DORR LLP, 300 PARK AVENUE, NEW YORK, NY, 10022, US

(21) Appl. No.: 10/354,567

(22) Filed: Jan. 30, 2003

(51) Int. Cl. B65G 60/00

(52) U.S. Cl. 414/788.8

(57) ABSTRACT

A plate feeding apparatus includes a first slide mechanism for horizontally moving one of a plurality of cassettes, a lift mechanism for supporting and vertically moving the cassette horizontally moved by the first slide mechanism, a second slide mechanism for horizontally moving the cassette vertically moved by the lift mechanism to a plate feeding position on top of the stack of cassettes, a transport mechanism for transporting the plates to the image recording apparatus from the cassette moved to the plate feed position, and a slip sheet removal mechanism for removing strip sheets each disposed between an adjacent pair of the plates.

### FIELD OF THE INVENTION

The present invention relates to the exposure of printing plates and more specifically to a storage device for storing unexposed plates and automatically loading them onto an exposure unit.

### BACKGROUND OF THE INVENTION

A CTP system accepts input jobs/pages written in a page description language, for example, Postscript. The jobs are sent through a raster image processor to a platemaker for exposure. The platemaker engine images the raster data on a plate, which is later mounted on the press, inked and made ready for printing.

The inclusion of a CTP system in a printing operation suggests a greater extent of automation that can be achieved. A full CTP process can automate, through the use of computers and special equipment, the transfer of information from the original layout to the press plate.

Also included in the automation of a CTP system is the media handling. It is necessary to supply plates individually from a plate supply area to the platemaker engine and it is desirable to reduce the amount of operator handling involved. Unexposed plates are normally supplied in packages of 25 to 100 plates, with interleaf paper-sheets between the plates for protecting the emulsion side of the plates, which is extremely sensitive to scratches. The stack of plates needs to be loaded into a supply area of a platemaker in a manner that will keep the stack of plates aligned with automation mechanisms for removing a plate from the stack, and for discarding the interleaf sheets from the stack.

U.S. Pat. No. 5,992,324 to Rombult et at describes an automatic plate loading system, including a plate handler in which plates are stored horizontally in equal-sized stacks and a slip-sheet removal mechanism. When the stack containing plates of the required size has been positioned in an access position inside the plate handler, a feeding mechanism picks the topmost plate and transports it to the imaging area. Air flow is then activated to peel off an edge of the slip-sheet, followed by gripping the peeled-off edge by mechanical “fingers” and lowering the cassette to further separate the slip-sheet from the plate above. The slip-sheet is then sucked by suction-cups, to separate it from the plate underneath and is rotatably driven out of the cassette and released.

The Lotem CTP machine, produced and sold by Creo Inc., Canada, also includes a horizontal plate-storage in cassettes, wherein the cassettes move vertically and the active cassette slides out of the storage area and into the imaging area, where a picker picks the topmost plate and subsequently the slip-sheet lying underneath the picked plate.

These loading systems, though efficient, require complicated and expensive mechanisms for the vertical movement of usually more than one cassette in the storage area, so as to position the required cassette in the appropriate height. Another shortcoming of the prior art systems is the excessive use of floor space for accommodating the plate storage area, the imaging system and transport space for moving the picked plate from the storage area to the imaging unit. The design of these systems requires additional floor space for supplying new plates to the plate storage area, on one of the sides of the plate storage area different from the picking side, to enable smooth operation of the loading/imaging system while refilling plates into empty cassettes.

U.S. Pat. No. 6,341,932 to Otsuji discloses a plate loading mechanism comprising a plurality of cassettes stacked vertically; a slide mechanism for horizontally moving one of the cassettes; a lift mechanism for supporting and vertically moving the one of the cassettes horizontally moved by the slide mechanism, to a plate feed position for feeding plates to the image recording apparatus; and a transport mechanism for transporting the plates to the image recording apparatus from the one of the cassettes moved to the plate feeding position by the lift mechanism.

This plate feeding apparatus is constructed to horizontally slide and then vertically move a cassette to place the cassette in the plate feed position for feeding plates to the image recording apparatus. The apparatus overcomes the first problem of the devices described above, namely the need to move vertically a number of plate-filled cassettes, yet, although proclaiming to be compact, fails to overcome the second problem of excessive floor space, as depicted in FIGS. 1 and 2.

The prior-art system of FIG. 1 comprises a plate-storage area 10, an elevator mechanism 20 for horizontally receiving a cassette from the plate-storage area 10 and moving vertically to a plate picking position and an imaging unit 30 for receiving a plate (as shown by arrow 40) from the plate picking mechanism and imaging it. The system additionally comprises a paper-sheet collection bin 50 and requires adequate floor space for pulling out a cassette 60 and re-filling it with new plates. The re-filling operation is done at the level/height of each individual cassette to be filled.

FIG. 2 is a schematic top-view of the same prior-art system as disclosed in U.S. Pat. No. 6,341,932.

There is a need for a fast and reliable process of plate loading to overcome the shortcomings of prior art systems.

### SUMMARY OF THE INVENTION

The present invention provides an improved method and apparatus for loading plates onto a platesetter in a CTP system.

In one aspect, there is provided a plate loading apparatus for loading plates stored in a plurality of cassettes to an image recording apparatus for recording images on the plates, comprising:

a stack comprising a plurality of cassettes stacked vertically;

a first slide mechanism for horizontally moving a chosen one of said cassettes;

a lift mechanism for supporting and vertically moving said chosen cassette horizontally moved by said slide mechanism, to a vertical position having substantially the height of said stack;

a second slide mechanism for horizontally moving said chosen cassette vertically moved by said lift mechanism to a plate feed position on top of said stack, for feeding plates to said image recording apparatus; and

a transport mechanism for transporting said plates to said image recording apparatus from said one of said chosen cassette moved to said plate feed position by said second slide mechanism.

The plate loading apparatus may additionally comprise a slip-sheet removal mechanism for removing slip-sheets disposed between each adjacent pair of said plates in said chosen cassette placed in said plate feed position.

In another aspect of the present invention there is provided a method of loading plates stored in a plurality of cassettes to an image recording apparatus for recording images on the plates, comprising the steps of:

providing a stack comprising a plurality of cassettes stacked vertically;

using a first slide mechanism for horizontally moving a chosen one of said cassettes;

using a lift mechanism for vertically moving said chosen cassette horizontally moved by said first slide mechanism, to a vertical position having substantially the height of said stack;

using a second slide mechanism for horizontally moving said chosen cassette vertically moved by said lift mechanism to a plate feed position on top of said stack, for feeding plates to said image recording apparatus; and

transporting said plates to said image recording apparatus from said one of said chosen cassette moved to said plate feed position.

The loading method may additionally comprise the step of removing slip-sheets disposed between each adjacent pair of said plates in said chosen cassette placed in said plate feed position.

In one embodiment of the method of the present invention, the method additionally comprising a process for refilling plates in an empty cassette situated in said stack, comprising the steps of:

vertically moving said lift mechanism to the general height of said empty cassette in said stack;

using said first slide mechanism for horizontally moving said empty cassette;

using said lift mechanism for vertically moving said empty cassette horizontally moved by said first slide mechanism to a filling position;

filling plates into said empty cassette in said filling position;

vertically moving said filled cassette back to its original height in said stack; and

using said first slide mechanism for horizontally moving said filled cassette into said stack.

In another embodiment, the method additionally comprises a process for refilling plates in an empty cassette situated in said plate feed position, comprising the steps of:

using said second slide mechanism for horizontally moving said empty cassette;

using said lift mechanism for vertically moving said empty cassette horizontally moved by said second slide mechanism to a filling position;

filling plates into said empty cassette in said filling position;

vertically moving said filled cassette back to its original height on top of said stack; and

using said second slide mechanism for horizontally moving said filled cassette onto the top of said stack.

In yet another embodiment, the method additionally comprises a process for refilling plates in an empty cassette situated in said plate feed position, said cassette having an original place inside said stack, comprising the steps of:

using said second slide mechanism for horizontally moving said empty cassette;

using said lift mechanism for vertically moving said empty cassette horizontally moved by said second slide mechanism to a filling position;

filling plates into said empty cassette in said filling position;

vertically moving said filled cassette back to the general height of said original place in said stack; and

using said first slide mechanism for horizontally moving said filled cassette into said original place inside said stack.

In another aspect of the present invention, there is provided a method of refilling plates in an empty cassette situated in a stack of cassettes, comprising the steps of:

using a slide mechanism for horizontally moving said empty cassette;

using a lift mechanism for vertically moving said empty cassette horizontally moved by said slide mechanism to a filling position;

filling plates into said empty cassette in said filling position;

vertically moving said filled cassette back to its original height in said stack; and

using said slide mechanism for horizontally moving said filled cassette into said stack.

In yet another aspect of the present invention, there is provided a method of refilling plates in an empty cassette situated on top of a stack of cassettes, comprising the steps of:

using a slide mechanism for horizontally moving said empty cassette;

using a lift mechanism for vertically moving said empty cassette horizontally moved by said slide mechanism to a filling position;

filling plates into said empty cassette in said filling position;

vertically moving said filled cassette back to its original height on top of said stack; and

using said slide mechanism for horizontally moving said filled cassette onto the top of said stack.

In an additional aspect of the present invention, there is provided a method of refilling plates in an empty cassette situated in a plate feed position on top of a stack of cassettes, said cassette having an original place inside said stack, comprising the steps of:

using a first slide mechanism for horizontally moving said empty cassette;

using a lift mechanism for vertically moving said empty cassette horizontally moved by said slide mechanism to a filling position;

filling plates into said empty cassette in said filling position;

vertically moving said filled cassette back to the general height of said original place in said stack; and

using a second slide mechanism for horizontally moving said filled cassette into said original place inside said stack.

### BRIEF DESCRIPTION OF THE DRAWINGS

FIG. 1 is an isometric schematic of an imaging system including plate loader, as exists in the prior art;

FIG. 2 is a schematic top view of the system of FIG. 1;

FIG. 3 is an isometric schematic of an imaging system including plate loader according to an embodiment of the present invention; and

FIG. 4 is a schematic top view of the system of FIG. 3.

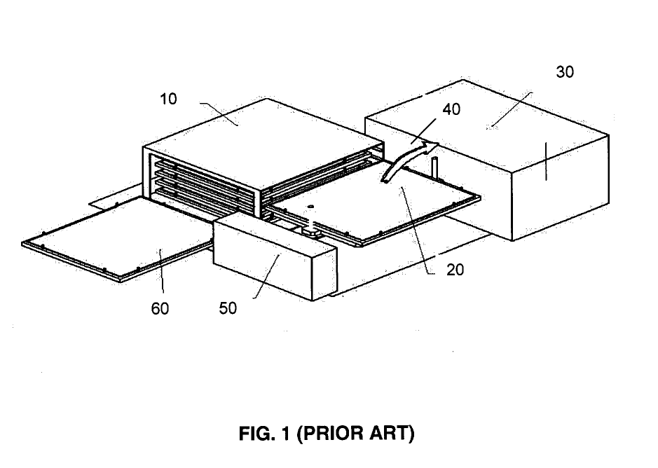

### DETAILED DESCRIPTION OF A PREFERRED EMBODIMENT

FIG. 3 is an isometric scheme of a preferred embodiment of the present invention. The system comprises a plate-storage area 10 and an elevator mechanism 20 for horizontally receiving a cassette from the plate-storage area 10 and moving vertically to a sliding position defined by height H from the floor level. The height H brings the bottom of the moved cassette to a position from which it can be horizontally moved to a plate picking position 70 on top of the plate-storage area. The horizontal movements may be performed by two separate sliding mechanisms or by the same sliding mechanism. The system additionally comprises an imaging unit 30 for receiving a plate (as shown by arrow 40) from the plate picking mechanism (not shown) and imaging it. The system additionally comprises a paper-sheet collection bin 50 and a slip-sheet removal mechanism (not shown) as known in the art.

The sliding and lifting mechanisms involved in the various motion described herein are known in the art and do not comprise part of the present invention.

Having positioned the cassette on top of the plate-storage area, the elevator 20 is now free to serve in a second capacity, to facilitate re-filling plates in the plate-storage area. To do so, the elevator 20 is vertically moved to the level of the cassette to be filled, by command from a controller (not shown) having information about the level of plates in each cassette, according to methods known in the art. When the elevator 20 has reached the appropriate level, the empty cassette is horizontally moved to the elevator, as described above with respect to a cassette for imaging. The elevator 20 may then be vertically moved to any predefined ergonomically suitable level for re-filling plates. After plates have been filled, the elevator mechanism moves the filled cassette back to its place in the plate-storage area, by equivalent vertical and horizontal movements.

In an alternative scenario, the active cassette at 70 may become empty while supplying plates to the imaging unit 30. If a re-fill is required immediately, the elevator will be vertically positioned at height H, the empty cassette horizontally moved to the top of the elevator and a re-filling operation as described above performed. When the cassette is filled, it may optionally be returned to position 70, for continued plate picking, or moved back to the plate storage area as described above.

In yet another embodiment, if the empty cassette is the active cassette at 70, and the same cassette is to remain active after plate filling, the filling operation may be performed at position 70, on top of the cassette stack.

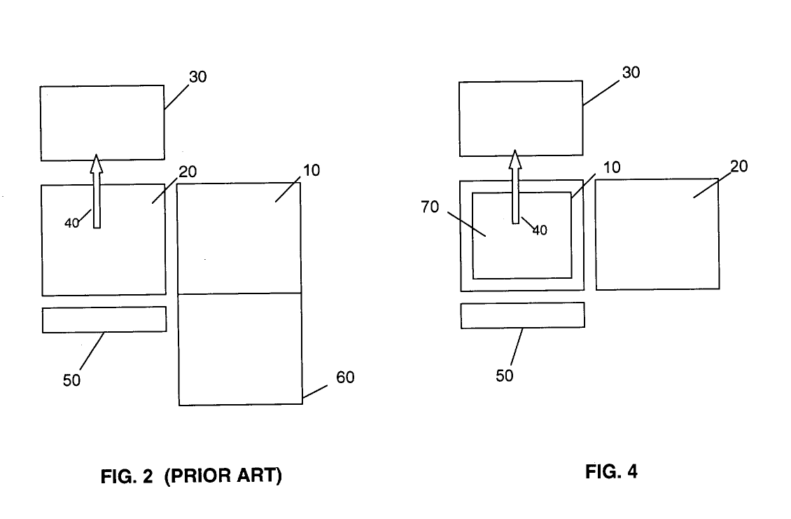

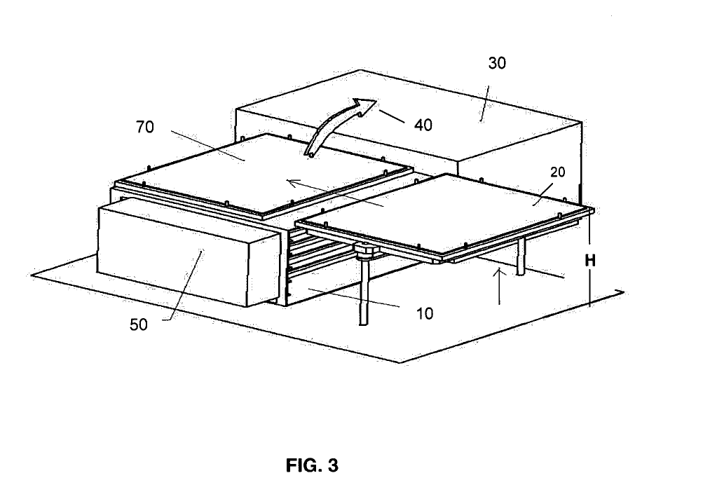

FIG. 4 is a schematic top-view of the system of the present invention, depicting the saved floor-space in comparison with the top-view of the prior-art system as depicted in FIG. 2.

1. A plate loading apparatus for loading plates stored in a plurality of cassettes to an image recording apparatus for recording images on the plates, comprising:
a stack comprising a plurality of cassettes stacked vertically;
a first slide mechanism for horizontally moving a chosen one of said cassettes;
a lift mechanism for supporting and vertically moving said chosen cassette horizontally moved by said slide mechanism, to a vertical position having substantially the height of said stack;
a second slide mechanism for horizontally moving said chosen cassette vertically moved by said lift mechanism to a plate feed position on top of said stack, for feeding plates to said image recording apparatus; and
a transport mechanism for transporting said plates to said image recording apparatus from said one of said chosen cassette moved to said plate feed position by said second slide mechanism.

2. A plate loading apparatus according to claim 1, additionally comprising a slip-sheet removal mechanism for removing slip-sheets disposed between each adjacent pair of said plates in said chosen cassette placed in said plate feed position.

3. A plate loading mechanism according to either of claims 1 and 2, wherein said first and second sliding mechanisms are the same.

4. A method of loading plates stored in a plurality of cassettes to an image recording apparatus for recording images on the plates, comprising the steps of:
providing a stack comprising a plurality of cassettes stacked vertically;
using a first slide mechanism for horizontally moving a chosen one of said cassettes;
using a lift mechanism for vertically moving said chosen cassette horizontally moved by said first slide mechanism, to a vertical position having substantially the height of said stack;
using a second slide mechanism for horizontally moving said chosen cassette vertically moved by said lift mechanism to a plate feed position on top of said stack, for feeding plates to said image recording apparatus; and
transporting said plates to said image recording apparatus from said one of said chosen cassette moved to said plate feed position.

5. The method according to claim 4, additionally comprising the step of removing slip-sheets disposed between each adjacent pair of said plates in said chosen cassette placed in said plate feed position.

6. The method of either of claims 4 and 5, additionally comprising a process for refilling plates in an empty cassette situated in said stack, comprising the steps of:
vertically moving said lift mechanism to the general height of said empty cassette in said stack;
using said first slide mechanism for horizontally moving said empty cassette;
using said lift mechanism for vertically moving said empty cassette horizontally moved by said first slide mechanism to a filling position;
filling plates into said empty cassette in said filling position;
vertically moving said filled cassette back to its original height in said stack; and
using said first slide mechanism for horizontally moving said filled cassette into said stack.

7. The method of either of claims 4 and 5, additionally comprising a process for refilling plates in an empty cassette situated in said plate feed position, comprising the steps of:
using said second slide mechanism for horizontally moving said empty cassette;
using said lift mechanism for vertically moving said empty cassette horizontally moved by said second slide mechanism to a filling position;
filling plates into said empty cassette in said filling position;
vertically moving said filled cassette back to its original height on top of said stack; and
using said second slide mechanism for horizontally moving said filled cassette onto the top of said stack.

8. The method of either of claims 4 and 5, additionally comprising a process for refilling plates in an empty cassette situated in said plate feed position, said cassette having an original place inside said stack, comprising the steps of:
using said second slide mechanism for horizontally moving said empty cassette;
using said lift mechanism for vertically moving said empty cassette horizontally moved by said second slide mechanism to a filling position;
filling plates into said empty cassette in said filling position;
vertically moving said filled cassette back to the general height of said original place in said stack; and
using said first slide mechanism for horizontally moving said filled cassette into said original place inside said stack.

9. The method of either of claims 4 and 5, additionally comprising using said plate feed position as a filling position for filling plates into an empty cassette at said plate feed position.

10. A method of refilling plates in an empty cassette situated in a stack of cassettes, comprising the steps of:
using a slide mechanism for horizontally moving said empty cassette;
using a lift mechanism for vertically moving said empty cassette horizontally moved by said slide mechanism to a filling position;
filling plates into said empty cassette in said filling position;
vertically moving said filled cassette back to its original height in said stack; and
using said slide mechanism for horizontally moving said filled cassette into said stack.

11. A method of refilling plates in an empty cassette situated on top of a stack of cassettes, comprising the steps of:
using a slide mechanism for horizontally moving said empty cassette;
using a lift mechanism for vertically moving said empty cassette horizontally moved by said slide mechanism to a filling position;
filling plates into said empty cassette in said filling position;
vertically moving said filled cassette back to its original height on top of said stack; and
using said slide mechanism for horizontally moving said filled cassette onto the top of said stack.

12. A method of refilling plates in an empty cassette situated in a plate feed position on top of a stack of cassettes, said cassette having an original place inside said stack, comprising the steps of:
using a first slide mechanism for horizontally moving said empty cassette;
using a lift mechanism for vertically moving said empty cassette horizontally moved by said slide mechanism to a filling position;
filling plates into said empty cassette in said filling position;
vertically moving said filled cassette back to the general height of said original place in said stack; and
using a second slide mechanism for horizontally moving said filled cassette into said original place inside said stack.
